(19) United States
(12) Patent Application Publication
(10) Pub. No.: US 2026/0176153 A1
(43) Pub. Date: Jun. 25, 2026

(54) METHOD FOR PREPARING MAGNETO-DIELECTRIC FERRITE MATERIALS FOR VUHF APPLICATION

(71) Applicants: Exxelia, Paris (FR); CENTRE NATIONAL D'ETUDES SPATIALES, Paris (FR)

(72) Inventors: Christian Ravagnani, Pessac (FR); Rémy Visna Paul Ul, Labouhere (FR)

(21) Appl. No.: 19/427,292

(22) Filed: Dec. 19, 2025

(30) Foreign Application Priority Data
Dec. 20, 2024 (FR) FR2414931

(51) Int. Cl. C01G 49/00

(52) U.S. Cl. CPC C01G 49/0063; C01P 2004/62; C01P 2006/12; C01P 2006/42

(57) ABSTRACT

The present disclosure relates to a method for preparing a ferrite material, including the following steps: S₁: grinding the ferrite particles P₁ with grinding balls B₁, to obtain the ferrite particles P₂, the diameter d₉₀ of the ferrite particles P₂ being smaller than the diameter d₉₀ of the particles P₁, S₁ being carried out at an energy E₁ greater than 1.5 kWh/kg; and S₂: grinding the ferrite particles P₂ with grinding balls B₂ to obtain the ferrite particles P₃, the diameter d₉₀ of the ferrite particles P₃ being smaller than the diameter d₉₀ of the particles P₂, S₂ being carried out at an energy E₂ greater than 5 kWh/kg, and the diameter of the balls B₁ being greater than the diameter of the balls B₂. The disclosure also relates to a magneto-dielectric ferrite material obtained by such a method, intended for use in the VUHF frequency band.

### FIELD

The present disclosure relates to a method for preparing a magneto-dielectric ferrite material from ferrite particles. It also relates to a magneto-dielectric ferrite material thus obtained. Such a material can be used in the field of communications for the manufacture of antennas, in particular suitable for operating in the very high frequency (VHF) band, comprised between 30 MHz and 300 MHz, and ultra-high frequency (UHF), comprised between 300 MHz and 3 GHZ, or VUHF.

### BACKGROUND

In the field of communications, it is observed that the miniaturization of an antenna is a major challenge, especially for antennas operating below the GHz. Indeed, the size of an antenna is directly proportional to the wavelength of the signal emitted/received, and this is of the order of a meter for VHF/UHF frequencies (VHF: 30 MHz to 300 MHz; UHF: 300 MHz to 3000 MHz). It is therefore not easy to reduce the size of an antenna whose frequency corresponds to a high wavelength, particularly of the order of a meter.

Among the different strategies used to achieve a miniature antenna (i.e. small compared to the wavelength), a commonly used one is to use the dielectric properties of a material so as to concentrate the fields into a smaller volume. The use of dielectric material with a high dielectric constant (ε′) enables a significant reduction in the antenna size, but is accompanied by a significant drop in performance (radiation efficiency, bandwidth) (R. K. Mongia, A. Ittipiboon, and M. Cuhaci, “Low profile dielectric resonator antenna using a very high permittivity material,” Electron. Lett., Vol 30 No. 17(1994) 1362-1663).

It has been shown in recent years that the use of magnetic materials with a high permeability enables overcoming this limitation. Indeed, the use of materials such as ferrites with a high magnetic permeability (μ′) would enable reducing the size of antennas while maximizing their efficiency. Indeed, although ε′ has a positive impact on dielectric losses and the amount of stored energy, it has been proven that ε′ also has a negative impact on bandwidth and antenna efficiency, and that μ′ has an opposite effect, i.e. a positive impact on these two parameters (M.A.C Niamien, S. Collardey, A. Sharaiha, K. Mahdjoubi, “Compact Expressions for Efficiency and Bandwidth of Patch Antennas Over Lossy Magneto-Dielectric Materials”, IEEE antennas and wireless propaga. letters, 10 (2011) 63-66). Another considerable advantage is that if the antenna is kept at iso-dimension, such a material would increase the performance of the antenna.

In the VUHF frequency bands, ferrites usually present high magnetic losses, making them unusable for this application. However, it has been shown that it is possible to reduce these losses by synthesizing these ferrites from powders obtained by co-precipitation and sintering at low-temperature (i.e. below 1000° C.) (A. Saini, K. Rana, A. Thakur, P. Thakur, J-L. Mattei, P. Queffelec, “Low loss Composite nano ferrite with matching permittivity and permeability in UHF band”, Materials Research Bulletin, 76, p. 94-99 (2016)). This method indeed enables obtaining nanoparticles which, once sintered at low temperature to avoid grain growth, enable the manufacture of ferrites whose microstructure is also nanometric. This would enable approaching a magnetic single-domain grain configuration and avoiding the contribution of magnetic walls to permeability (with the magnetic losses then being limited). However, this co-precipitation method can be heavy and costly to implement from an industrial point of view.

### SUMMARY

For these reasons, the present disclosure aims to provide a method for preparing a material that enables the manufacture of miniature antennas suitable for use in VHF and/or UHF frequency bands.

In particular, the present disclosure aims to provide a method for preparing a magneto-dielectric ferrite material with low magnetic losses in the VHF and/or UHF frequency bands.

The present disclosure particularly aims to provide such a preparation method that is less heavy and less costly to implement from an industrial point of view than the current methods.

The disclosure therefore relates to a method for preparing a magneto-dielectric ferrite material, said method comprising the following steps:
a step S₁ of grinding the ferrite particles P₁ with grinding balls B₁, to obtain the ferrite particles P₂,
the diameter d₉₀ of the ferrite particles P₂ being smaller than the diameter d₉₀ of the particles P₁,
said step S₁ being carried out at an energy E₁ greater than 1.5 kWh/kg, preferably greater than 2 kWh/kg, preferably greater than 2.5 kWh/kg, preferably greater than 3 kWh/kg, and
a step S₂ of grinding the ferrite particles P₂ with the grinding balls B₂, to obtain the ferrite particles P₃,
the diameter d₉₀ of the ferrite particles P₃ being smaller than the diameter d₉₀ of the particles P₂,
said step S₂ being carried out at an energy E₂ greater than 5 kWh/kg, preferably greater than 5.5 kWh/kg, preferably greater than 6 kWh/kg,
and the diameter of the balls B₁ being greater than the diameter of the balls B₂.

Preferably, the method according to the disclosure is a wet method.

Ferrite particles are understood as particles composed of iron (III) oxide and one or more metal oxides.

Preferably, in the method according to the disclosure, the ferrite particles P₁ comprise, preferably consist of, iron oxide (Fe₂O₃) particles and one or more oxides chosen from nickel oxide (NiO), cobalt oxide (CoO), zinc oxide (ZnO), manganese oxide (MnO), and copper oxide (CuO). The ferrite particles P₁ preferably all have the same oxide composition.

According to the method of the disclosure, the grindings of steps S₁ and S₂ are carried out in mills.

The energy E means the effective energy transferred from the mill to the particles during the grinding steps, which is defined as follows:

$$E = \frac{Enet}{m} \times t$$

with Eₙₑₜ the net energy corresponding to the gross energy supplied to the mill minus the energy consumed by this mill when it operates empty,
m the mass of particles in the mill chamber, and
t the grinding duration.

In the following description, the energy E₁ will refer to the effective energy E of the grinding step S₁ and the effective energy E₂ will refer to that of the grinding step S₂.

### BRIEF DESCRIPTION OF THE DRAWINGS

FIG. 1 is a graph representing the magnetic permeability and magnetic losses according to the frequency in MHz for different materials:
Curves 1 and 1′ represent the respective magnetic losses (“tan δ—sintering 900° C., high-energy method according to the disclosure”) and magnetic permeability (“μ′—sintering 900° C., high-energy method according to the disclosure”) of a material obtained according to the method of Example 2 and sintered at a temperature of 900° C.
Curves 2 and 2′ represent the respective magnetic losses (“tan δ—sintering 850° C., high-energy method according to the disclosure”) and magnetic permeability (“μ′—sintering 850° C., high-energy method according to the disclosure”) of a material obtained according to the method of Example 2 and sintered at a temperature of 850° C.
The other curves represent the magnetic losses and magnetic permeability of materials obtained according to a comparative low-energy method and sintered at different temperatures (from darkest to lightest: 1180, 1140, and 1100° C.).

FIG. 2 is a graph representing the magnetic permeability and magnetic losses according to the frequency in MHz for the material obtained according to the method of Example 3.

### DETAILED DESCRIPTION

The “diameter” of a ferrite particle P₁, P₂ or P₃ means the “equivalent spherical volume diameter”. The equivalent spherical volume diameter corresponds to the result of the size measurement of said particle by the laser diffraction particle size technique (Laser Scattering Particle Size Distribution) described below.

The “diameter d₉₀” means that 90% of the particles, by volume, have an equivalent spherical diameter of value less than or equal to the value of d₉₀.

The “diameter d₅₀” means that that 50% of the particles, by volume, have an equivalent spherical diameter of value less than or equal to the value of d₅₀.

The “diameter d₁₀” means that that 10% of the particles, by volume, have an equivalent spherical diameter of value less than or equal to the value of d₁₀.

The values of the diameters d₉₀, d₅₀, and d₁₀ were obtained by analysis using the laser diffraction particle size technique (Laser Scattering Particle Size Distribution). As an example of such an analysis, it can be carried out from an aqueous suspension of particles using a Laser Scattering Particle Size Distribution Analyser Malvern model Mastersizer 3000. For the particle size distribution analyses according to the disclosure, samples of ferrite powder suspensions (about 5 mL) were taken with a pipette at the end of the grinding cycle. For the measurement, a small portion of the freshly taken sample at the end of the grinding cycle was introduced drop by drop into the measurement accessory chamber Hydro MV of the Malvern model Mastersizer 3000 equipment, containing deionized water, waiting with each drop introduced for the stabilization of the obscuration value, up to a value of around 5% (the decrease in the laser energy level received by the detector due to the introduction of particles into the measurement cell in relation to the incident laser energy level). The equipment settings used for the measurement are:
Suspension agitation speed: 2000 rpm
Ultrasound: 0%
Refractive index of particles: 2.360
Absorption index of particles: 1.000
Refractive index of particles in blue: 2.360
Absorption index of particles in blue: 1.000
Refractive index of the dispersant (water): 1.330
Diffraction model: Mie
Analysis model: general
Analysis sensitivity: normal

### Obtaining the Ferrite Particles P₁

In order to obtain the ferrite particles P₁, raw materials in the form of oxide and/or carbonate powders are first selected according to the desired magneto-dielectric ferrite material composition. For example, the following oxides and carbonates are selected: Fe₂O₃, CO₃O₄, NiO, ZnO, CuCO₃·xH₂O, MnCO₃.

Preferably, these oxides and/or carbonates in powder form are weighed, then simultaneously mixed and ground to form intimately mixed oxide and/or carbonate powders.

Preferably, the mixing and grinding of the selected oxides and/or carbonates are carried out simultaneously in an aqueous medium by/in a ball mill, a jar mill or an attrition mill.

For example, grinding in a ball mill or a jar mill containing steel grinding elements (balls) takes place for a duration of between 15 hours and 25 hours, preferably between 18 hours and 22 hours. In particular, grinding takes place for 20 hours.

Preferably, the oxide and/or carbonate powders thus obtained are then subjected to a calcination step, where the mixed and ground oxide and/or carbonate powder is heated to high temperature to enable the breakdown of carbonates and chemical reactions between oxides to form the desired ferrite phase. In other words, the ferrite particles P₁ are preferably obtained by a step of calcination of oxide and/or carbonate powders. Advantageously, the calcination is carried out at a temperature of between 800° C. and 1100° C. Advantageously, the calcination is carried out for a duration ranging from 2 hours to 4 hours. Thus, according to a preferred embodiment, the method comprises a step of obtaining the ferrite particles P₁ such that the ferrite particles P₁ are obtained by a step of calcination of oxide and/or carbonate powder, said calcination step being carried out preferably at a temperature ranging from 800° C. to 1100° C. and, preferably, for a duration ranging from 2 h to 4 h.

The particles obtained at the end of calcination may optionally undergo a second grinding in order to obtain the ferrite particles P₁.

This grinding is preferably a wet grinding in a ball mill or a jar mill with steel balls. In particular, this grinding takes place for a duration of between 30 hours and 40 hours, preferably between 34 hours and 38 hours. The second grinding may optionally be carried out in an attrition mill.

The ferrite particles thus obtained are the ferrite particles P₁. Advantageously, the diameter d₉₀ of the particles P₁ is less than 50 μm, preferably less than 40 μm, preferably less than 30 μm. According to one embodiment, the diameter deo of the particles P₁ is between 10 μm and 50 μm. Preferably, the ferrite particles P₁ have a specific surface area of at least 2 m²/g, preferably at least 2.5 m²/g, preferably at least 3 m²/g.

The “specific surface area” means the ratio of the total surface area of all particles (in m²) to the total mass of all said particles (in grams).

The specific surface area of particle powders was measured by the BET method (Brunauer, Emmett and Teller Method) with “Micromeritics FlowSorb II 2300” equipment. According to the BET method, the specific surface area of a powder is calculated from the volume of a gas, in this case a 70% He-30% N₂ mixture, which is adsorbed on the surface of a known mass of this powder during the measurement. For the preparation of the sample to make specific surface area measurements, 5 g of the respective ferrite powder P₁, P₂ or P₃ from the drying of suspensions after the grinding steps, after calcination of the raw materials, S₁ and S₂, were placed in an oven at 110° C. overnight to eliminate any moisture. To make the measurement, a clean and dry measurement cell is weighed before and after being filled with 5 g of particle powder P₂ or P₃ and placed in the degassing location of the measurement equipment. The powder is maintained at 250° C. for 30 minutes to eliminate any residual moisture and possibly other gas molecules adsorbed on the surface of the powder before measurement. Then, the measurement cell is transferred to the measurement location. After calibration of the equipment, the measurement is carried out.

### The Grindings

The method according to the disclosure comprises two grinding steps, S₁ and S₂, of the ferrite particles P₁ and P₂ respectively. Preferably, the grinding of the particles P₁ of step S₁ is a high-energy grinding. Preferably, the grinding of particles P₂ of step S₂ is a high-energy grinding. Advantageously, the grinding of particles P₁ of step S₁ and the grinding of particles P₂ of step S₂ are both high-energy grindings.

High-energy grinding is a grinding that enables preparing nanostructured materials.

“High energy” means a net energy greater than 1.5 kWh/kg transmitted to the grinding medium, during the grinding step.

According to the method of the disclosure, the high-energy grindings of steps S₁ and S₂ consist of agitating the respective ferrite particles P₁ and P₂ with grinding balls in a sealed chamber. Under the effect of collisions and/or friction, the ferrite particles fracture to form smaller particles. During the collisions and/or friction of the balls on the ferrite particles P₁ or P₂, there is in effect a transfer of kinetic energy from the grinding balls to the ferrite particles to cause the fracture and reduction in size of the particles.

The grindings of steps S₁ and S₂ are characterized by the energy E, energies E₁ and E₂, respectively, which corresponds to the energy transferred from the mill to the particles:

$$E = \frac{Enet}{m} \times t$$

with Eₙₑₜ the net energy corresponding to the gross energy supplied to the mill minus the energy consumed by this mill when it operates empty,
m the mass of particles in the mill chamber, and
t the grinding duration.

Advantageously, the grindings of steps S₁ and S₂ are carried out with an attrition mill under conditions that maximize the energy transfer from the mill to the effective size reduction of the particles.

Moreover, the filling rate of the mill represents the volume occupied by the grinding elements (balls) in relation to the total volume of the mill chamber.

Preferably, the grindings of steps S₁ and S₂ independently have a filling rate of less than 75%, preferably less than 70%, preferably less than 65%.

Advantageously, the grinding balls B₁ and B₂ used for the grindings of the respective steps S₁ and S₂ are zirconium oxide balls. In particular, the balls B₁ and B₂ are zirconium oxide balls, or zirconia, of the ZrO₂ formula. Preferably, the balls B₁ and B₂ are zirconia balls stabilized with yttrium oxide.

### Step S₁

The method according to the disclosure comprises a step S₁ of grinding the ferrite particles P₁ with grinding balls B₁, to obtain the ferrite particles P₂.

Preferably, the grinding of step S₁ is a high-energy grinding as defined above. In particular, the grinding of step S₁ is carried out at an energy E₁ of greater than 1.5 kWh/kg, preferably greater than 2 kWh/kg, preferably greater than 2.5 kWh/kg, preferably greater than 3 kWh/kg.

Advantageously, the grinding of step S₁ is carried out for a duration of 2 h to 10 h and preferably of 3 h to 8 h.

Preferably, the grinding of step S₁ is carried out with an attrition mill, preferably an attrition mill containing accelerator elements in the grinding chamber. Preferably, said accelerator elements may be of the DYNO®-ACCELERATOR type. For example, the DYNO MILL ECM AP 05 mill manufactured by WAB Group can be used for grinding the ferrite particles P₁.

The diameter of the grinding balls B₁ used in step S₁ is preferably between 0.3 mm and 1 mm, preferably between 0.3 mm and 0.8 mm, preferably between 0.3 mm and 0.6 mm.

According to one advantageous embodiment, during step S₁ of grinding, the ferrite particles P₁ are in a suspension. According to this embodiment, the suspension of the ferrite particles P₁ comprises, preferably consists of, the ferrite particles P₁ and deionized water; preferably, the ferrite particles P₁ are present at about 1.6 kg per liter of deionized water.

According to such an embodiment, the method may comprise the addition before the grinding step E₁ of a dispersing agent to the suspension containing the particles P₁. The dispersing agent advantageously prevents the incremental agglomeration of the ferrite particles as the size of said particles is reduced. The dispersing agent thus maintains a sufficiently low viscosity of the suspension to enable a good grinding efficiency of said suspension even though it has a high concentration of the ferrite particles. In other words, a dispersing agent can be added to the aqueous suspension containing the particles P₁ so that the mill chamber used in step S₁ comprises the aqueous suspension of particles P₁, the grinding balls B₁ and a dispersing agent.

In particular, the dispersing agent is a polyelectrolyte polymer. The dispersing agent is preferably a preparation of alkali-free carboxylic acid, such as, for example, Dolapix CE64 (Zschimmer & Schwarz GmbH Co., DE).

When present, the dispersing agent preferably represents from 0.5 to 4%, preferably from 1 to 3%, more preferably from 1.5 to 2.5% of the mass of the aqueous suspension containing the particles P₁.

Thus, according to one embodiment, during step S₁ of grinding, the ferrite particles P₁ are in a suspension, preferably in a water suspension. Advantageously, the suspension further comprises a dispersing agent, preferably chosen from polyelectrolyte polymers, more preferably carboxylic acids.

The grinding of step S₁ enables obtaining the ferrite particles P₂.

The diameter d₉₀ of the particles P₂ is smaller than the diameter d₉₀ of the particles P₁.

Preferably, the diameter d₉₀ of the particles P₂ is less than 1.5 μm, preferably less than 1.0 μm, preferably less than 0.8 μm.

### Step S₂

The method according to the disclosure comprises a step S₂ of grinding the ferrite particles P₂ with the grinding balls B₂ to obtain the ferrite particles P₃.

Preferably, the grinding of step S₂ is a high-energy grinding as defined above. In particular, the grinding of step S₂ is carried out at an energy E₂ greater than 5 kWh/kg, preferably greater than 5.5 kWh/kg, preferably greater than 6 kWh/kg.

Advantageously, the grinding of step S₂ is carried out for a duration of 2 h to 10 h, and preferably 3 h to 8 h.

Preferably, the grinding of step S₂ is carried out with an attrition mill, preferably an attrition mill containing accelerator elements, preferably of the DYNO®-ACCELERATOR type, in the grinding chamber.

For example, the DYNO MILL ECM AP 05 mill manufactured by WAB Group can be used for grinding the ferrite particles P₂.

The diameter of the grinding balls B₂ used in step S₂ is preferably less than 0.3 mm, preferably less than 0.2 mm, preferably less than or equal to 0.1 mm.

According to one embodiment, the diameter of the balls B₁ is strictly greater than the diameter of the balls B₂.

According to one embodiment, during step S₂ of grinding, the ferrite particles P₂ are in a suspension, preferably in a water suspension. Advantageously, the suspension further comprises a dispersing agent, preferably chosen from polyelectrolyte polymers, more preferably carboxylic acids.

According to this embodiment, the method therefore comprises the addition of a dispersing agent to the aqueous suspension containing the particles P₂ before the grinding step S₂. In other words, a dispersing agent can be added to the aqueous suspension containing the particles P₂ so that the mill chamber of step S₂ comprises the aqueous suspension of particles P₂, the grinding balls B₂ and a dispersing agent.

In particular, the dispersing agent is a polyelectrolyte polymer. The dispersing agent is preferably a preparation comprising carboxylic acid, advantageously alkali-free carboxylic acid, such as Dolapix CE64 (Zschimmer & Schwarz GmbH Co., DE).

When present, the dispersing agent preferably represents between 0.1 and 3%, preferably between 0.3 and 2.5%, more preferably between 0.5 and 2% of the mass of the aqueous suspension containing the particles P₂.

The grinding of step S₂ enables obtaining the ferrite particles P₃.

The diameter d₉₀ of the particles P₃ is smaller than the diameter d₉₀ of the particles P₂.

Preferably, the diameter d₉₀ of the particles P₃ is less than 200 nm, preferably less than 150 nm, preferably less than 120 nm.

Preferably, the diameter d₅₀ of the particles P₃ is less than 100 nm, preferably less than 80 nm and/or the diameter d₁₀ of the particles P₃ is less than 60 nm, preferably less than 50 nm.

Advantageously, the particles P₃ have a specific surface area of at least 20 m²/g, preferably at least 30 m²/g, preferably at least 40 m²/g, preferably at least 60 m²/g, preferably at least 70 m²/g.

Preferably, the method according to the disclosure enables obtaining a volume of at least 60%, preferably at least 75%, preferably at least 85% of the particles P₃ having a diameter of less than 100 nm, in relation to the total volume of the particles P₃ obtained.

### Additional Steps

According to one embodiment, the method according to the disclosure further comprises at least one step of shaping the particles P₃ into solid material following step S₂.

Thus, according to one embodiment of the method, step S₂ is followed by a step of pressing the ferrite particles P₃, preferably uniaxial pressing and/or isostatic pressing.

Advantageously, the pressing step is preceded by a step of coating or atomization of the ferrite particles P₃ to improve the behavior of the powder particles P₃ during the pressing step. According to this embodiment, the method according to the disclosure therefore comprises:
a step S₁ of grinding the ferrite particles P₁ with grinding balls B₁, to obtain the ferrite particles P₂,
the diameter d₉₀ of the ferrite particles P₂ being smaller than the diameter d₉₀ of the particles P₁,
said step S₁ being carried out at an energy E₁ greater than 1.5 kWh/kg, preferably greater than 2 kWh/kg, preferably greater than 2.5 kWh/kg, preferably greater than 3 kWh/kg, and
a step S₂ of grinding the ferrite particles P₂ with grinding balls B₂, to obtain the ferrite particles P₃,
the diameter d₉₀ of the ferrite particles P₃ being smaller than the diameter d₉₀ of the particles P₂,
said step S₂ being carried out at an energy E₂ greater than 5 kWh/kg, preferably greater than 5.5 kWh/kg, preferably greater than 6 kWh/kg,
and the diameter of the balls B₁ being greater than the diameter of the balls B₂;
a coating or atomization step of the ferrite particles P₃; and
a step of pressing the coated or atomized the ferrite particles P₃, preferably uniaxial pressing and/or isostatic pressing.

Preferably, the step of shaping the particles P₃ into solid material is done by pressing.

Preferably, the pressing performed is uniaxial pressing. Alternatively, the uniaxial pressing is followed by isostatic pressing. Alternatively, the pressing performed is isostatic pressing. The pressing enables shaping the ferrite particles P₃ into a material. The material is preferably in the form of plates, discs, cylinders, or toroid.

Advantageously, the method according to the disclosure comprises a coating or atomization step of particles P₃ before shaping. This coating or atomization step is advantageously carried out with the addition of binder(s) and/or plasticizer(s). Preferably, the binder is a polyvinyl alcohol (PVA), such as OPTAPIX PAF 35. Preferably, the plasticizer is a Polyethylene glycol, such as PEG 400. The coating or atomization step, as well as the binder(s) and/or plasticizer(s) used in this step, are well known to those skilled in the art. Binders and plasticizers are organic agents typically used to improve the behavior of a ceramic powder in the pressing step (filling molds with powder, creep of granules during pressing, reduction of pressure needed to achieve a given density of the piece during pressing, increased strength of the pressed piece, etc.). Such behavior is particularly important in an industrial pressing method and/or for the manufacture of large pieces.

According to one embodiment, the step of pressing the ferrite particles P₃ is further followed by a heat treatment of the material thus shaped.

In particular, the heat treatment of the shaped material is sintering. Preferably, the sintering is carried out at a plateau temperature ranging from 800° C. to 1000° C. Advantageously, the sintering is carried out at a plateau temperature lower than 1000° C., preferably lower than 940° C., more preferably ranging from 800° C. to 900° C. or from 800° C. to 850° C.

Typically, the sintering is carried out under an oxidizing atmosphere, such as in air.

In particular, the sintering comprises a heating period by plateaus ranging from 175° C. to 375° C., each plateau having a duration of between 1 hour and 48 hours. These plateaus of between 175° C. and 375° C. serve to burn and eliminate organic components such as dispersants, binders, and/or plasticizers that may have been introduced in the steps of grinding, coating and/or atomization of the ferrite particles.

### Material Obtained

The method according to the disclosure enables obtaining a magneto-dielectric ferrite material.

Preferably, the material obtained has a relative dielectric permittivity εᵣ of greater than 1 and/or a relative magnetic permeability μᵣ of greater than 1. Preferably, the method according to the disclosure enables obtaining a magneto-dielectric ferrite material with dielectric permittivity εᵣ of between 3 and 30, preferably between 6 and 22, and magnetic permeability μᵣ of between 2 and 40, preferably between 4 and 30.

“Relative dielectric permittivity, εᵣ” means the resistance of a material to producing an electric field (εᵣ=ε/ε₀, where ε is the permittivity of the material and ε₀ is a constant and corresponds to the permittivity of the vacuum).

The dielectric permittivity is preferably evaluated based on perturbation theory, applied to a rectangular cavity.

The method of analyzing dielectric permittivity is preferably as follows.

The setup used for the analysis consists of the following elements: 10 MHz-26.5 GHz HP8340A synthesizer, 22.92×10.20, ×90.02 cavity with a no-load resonance frequency of 8235 MHz, The Wave Solution PS-16-SBB-402-402-B-M90 in silver-plated brass with UBR100 flanges, 10 MHz-26.5 GHz HP85025B detector, HP8757A scalar analyzer.

The measurement cavity is formed of a section of standard WR90 waveguide (internal section WR90=22.92×10.20 mm²), closed at the ends by plates with 4 mm diameter holes. It is coupled by the holes at the input to the synthesized HF microwave source, and at the output with the detector to the analyzer. A sample of the sintered and machined material in the form of a rod with a constant circular section of diameter ˜1 mm, previously dried between 150° C. and 200° C. for at least 30 min, is introduced at its center at the maximum of the HF electric field. The measurement is carried out at a frequency band around the resonance frequency of the empty cavity, 8235 MHz. The frequency and width of the resonance peak at half-height are measured with the empty measurement cavity and then with the rod. The relative dielectric permittivity εᵣ is calculated from the resonance frequency values, measured with the empty cavity and the cavity containing the sample, and from the volume of the cavity and that of the rod sample used for the measurement in the cavity.

“Relative magnetic permeability, μᵣ” means the ability of a material to conduct magnetic flux in relation to the vacuum (μᵣ=μ/μ₀, where μ is the magnetic permeability of the material and μ₀ is a constant and represents the magnetic permeability of the vacuum).

The application of a magnetic flux created by an alternating electric current generates a magnetic flux and magnetic losses in a magnetic material. The permeability of a magnetic material under a magnetic flux created by an alternating electric current is defined as the complex relative magnetic permeability μᵣ* where:

$${u}_{r}^{*} = {u}_{r}^{′} - i {μ}_{r}^{″}$$

where
μᵣ′ is the real part of the complex relative magnetic permeability, linked to the energy stored in the material by the application of the magnetic flux created by an alternating electric current
μᵣ″ is the imaginary part of the complex relative magnetic permeability corresponding to the energy dissipated in the material by different mechanisms due to the application of the magnetic flux created by an alternating electric current (magnetic losses)
and i is an imaginary number whose square has the value of −1

In particular, the method according to the disclosure enables obtaining a magneto-dielectric ferrite material with low magnetic losses at frequencies of between 1 and 1000 MHz. Low magnetic losses means that the loss tangent tan op is less than 0.1. The loss tangent is defined as: tan δ_{μ}=μᵣ″/μᵣ′.

The relative magnetic permeability μr and the magnetic loss tangent tan Ou were obtained using a “Keysight model E4991B” impedance analyzer from the inductance and impedance values measured in a coaxial cell mounted without and with the magnetic material (inductance method) in a frequency band from 1 MHz to 1000 MHz on toroid samples in APC7 format (Øext7×Øint3) manufactured by the method according to the disclosure.

Preferably, tan δ_{μ} is less than 0.1 in the frequency band from 1 to 1000 MHz, preferably from 1 to 600 MHz, preferably from 1 to 590 MHz, preferably from 1 to 250 MHz, preferably from 1 to 200 MHz, more preferably from 1 to 160 MHz. Advantageously, tan δ_{μ} is less than 0.08, preferably less than 0.06, preferably less than 0.05 in the frequency band from 1 to 150 MHz.

A ferrite material obtained by the method according to the disclosure is usable as an antenna material in VUHF frequency bands, for example, particularly in a frequency range from 1 to 1000 MHz, preferably from 1 to 800 MHz, preferably from 1 to 600 MHz, preferably from 1 to 590 MHz, preferably from 1 to 250 MHz, preferably from 1 to 200 MHz, more preferably from 1 to 160 MHz.

According to one embodiment, the method according to the disclosure also enables obtaining a ferrite material with a microstructure whose grain size is less than 200 nm, preferably less than 150 nm, preferably less than 120 nm, preferably less than 100 nm.

Preferably, the grain size of the sintered ferrite material is obtained by image analysis of EBSD (Electron BackScattered Diffraction) orientation mapping of the material's microstructure performed by Scanning Electron Microscopy (SEM). The EBSD orientation mapping technique is widely used for characterizing the microstructure and local crystallographic texture of polycrystalline materials. The Scanning Electron Microscopy technique enables observation and obtaining information from the surface of a material by processing the radiation generated by the interaction of the material with an accelerated electron beam emitted by the Scanning Electron Microscope. In this case, the radiation analyzed to generate the orientation mapping image corresponds to backscattered electrons produced by the diffraction of an electron beam having struck the material at a significant angle. Software then calculates the crystalline orientation of the material from the diffraction pattern (Kikuchi pattern) and generates a map where each grain or crystallite is represented by a color. This map provides information such as grain size and their distribution, to form the material's microstructure.

Advantageously, the method according to the disclosure enables obtaining a ferrite material with the following composition:

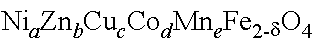

with:

$$2 ( a + b + c + d + e ) + 3 ( 2 - δ ) = 8$$

$$0.05 \leq b \leq 0.5$$

$$0 \leq c \leq 0.25$$

$$0.005 \leq d \leq 0.25$$

$$0 \leq e \leq 0.1$$

$$0 \leq δ \leq 0.08 .$$

In some embodiments, the material has the composition as described above with 0.05≤b≤0.45 and/or 0<δ≤0.08 (c, d, and e are as described above, b or δ, where applicable, is as described above, and 2(a+b+c+d+e)+3 (2−δ)=8).

The disclosure also relates to a ferrite material that can be obtained by the method described above. Such a material is particularly useful in VHF, UHF and/or VUHF antennas.

More particularly, the present disclosure relates to a ferrite material that can be obtained by the method described above, in which the pressing step of the particles P₃ is followed by a sintering step carried out at a plateau temperature of lower than 1000° C., preferably lower than 940° C., more preferably ranging from 800° C. to 900° C. or from 800° C. to 850° C. The material has a microstructure whose grain size is less than 200 nm, preferably less than 150 nm, preferably less than 120 nm, preferably less than 100 nm. Such a material typically has a density ranging from 3.7 to 5.3 g/cm³. The material preferably has a composition as described above.

Advantageously, the antenna is adapted to operate between 1 to 1000 MHz, preferably from 1 to 800 MHz, preferably from 1 to 600 MHz, preferably from 1 to 590 MHz, preferably from 1 to 250 MHz, preferably from 1 to 200 MHz, more preferably from 1 to 160 MHz.

### EXAMPLES

### Example 1: Grinding Method Outside the Disclosure

The following raw materials are selected and weighed according to Table 1:

TABLE 1

| Raw materials | Mass (g) |
|---|---|
| Fe₂O₃ | 1905.66 |
| NiO | 587.07 |
| ZnO | 353.03 |
| CuCO₃•xH₂O | 70.21 |
| MnCO₃ | 75.82 |
| Co₃O₄ | 8.21 |

### Preparation of the Ferrite Particles

The protocol is as follows:
3.0±0.1 kg of raw materials as detailed in Table 1 are weighed and placed in an 8 L jar of a jar mill (A. Faure Type 28V30-11) containing 11.4 kg of 100C6 steel balls (supplied by Maridt GmbH) of varied diameters and according to the approximate quantities shown in Table 2;
3.3±0.1 L of deionized water and 20±2 g of Dolapix CA dispersant supplied by Zschimmer & Schwarz GmbH Co., DE are added,
grinding is carried out for a duration of 20 hours,
the suspension obtained is then dried at 200° C. for 4 to 6 h and then at 120° C. for about 14 to 16 h until the moisture content is <0.2% (measured in a SPEEDY MOISTURE TESTER from THOMAS ASHWORTH).
the powder is then subjected to a calcination step, at a temperature of 1050° C. for 3 hours, then
the particles obtained at the end of calcination are ground for a duration of 36 hours in a jar mill under the same conditions as those of the first grinding, apart from the addition of the dispersant (no dispersant added).

Diameters and approximate quantities of 100C6 steel balls used in the grinding of raw materials for the preparation of the ferrite particles:

TABLE 2

| Diameter (mm) | Ball Mass (kg) |
|---|---|
| 27 to 32 | 6.6 |
| 13 to 15 | 2.1 |
| 9 to 10 | 2.7 |

The ferrite particles obtained have a specific surface area of between 2 m²/g and 4 m²/g, a diameter d₉₀ of about 30 μm, and have the following composition:

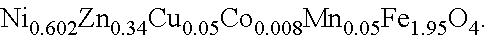

### Grinding of the Ferrite Particles:

The ferrite particles obtained above are ground by a steam jet mill, under the reference of Steam jet mill s-jet 25 from Netzsch.

The grinding is carried out with the following parameters:
Dynamic separator speed: 10000 rpm
Grinding air pressure: 7 bar
Flow rate: 59 m³/h

The particles thus obtained are observed by Scanning Electron Microscopy (SEM) with the JEOL JSM-IT200 equipment in Backscattered Electron (BSE) mode with an acceleration voltage of 5 kV, WD (Working Distance) 10 mm. The observed particles have a diameter of about 1 μm according to the visual analysis of the image.

### Example 2: Grinding Method According to the Disclosure

### Preparation of the Ferrite Particles:

The protocol for preparing the ferrite particles and their composition are the same as those of Example 1.

The ferrite particles P₁ thus obtained have a specific surface area typically between 2 m²/g and 4 m²/g, a diameter do of about 30 μm, and have the following composition:

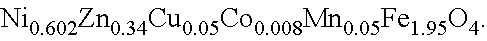

### Grinding of the Ferrite Particles:

The ferrite particles P₁ obtained above are ground in two steps by an attrition mill under the reference DYNO MILL ECM AP 05 from the WAB Group.

First step S₁:
the ferrite particles P₁ are suspended in an aqueous slurry, typically at about 1.6 kg of ferrite powder per liter of deionized water,
2% by weight in relation to the total weight of the slurry of dispersing agent (Dolapix CE64) is added to the slurry,
the slurry is ground for 4 hours with yttria-stabilized zirconium oxide balls of 0.3 mm diameter, with the following parameters:
   mill speed: 12 m/s
   energy E₁: between 1.8 and 2.1 kWh/kg

At the end of step S₁, the ferrite particles P₂ are obtained.

### Second Step S₂:

0.8% of dispersing agent (Dolapix CE64) by weight relative to the total weight is added to the ground ferrite suspension (suspension of the ferrite particles P₂) in the previous step,
the slurry is ground for 7.5 hours with yttria-stabilized zirconium oxide balls of 0.1 mm diameter, with the following parameters:
   mill speed: 14 m/s
   energy E₂: between 6.2 and 7.1 kWh/kg

At the end of step S₂, the ferrite particles P₃ are obtained.

The particles P₂ and P₃ thus obtained are observed by Scanning Electron Microscopy (SEM) using the FEI Quanta FEG 650 equipment in Large Field Detector Low Vacuum mode, with an acceleration voltage of 20 kV, WD (Working Distance) 10 mm, HFW (Horizontal Field Width: Horizontal field width) 5.60 μm.

The size of the particles P₃ is less than 200 nm, according to 20 dimensional measurements made by image analysis. Due to the very small size of the particles, the measurements are only indicative, to verify the consistency of particle size distribution measurements by the Laser Scattering Particle Size Distribution method.

In addition, the particle size and specific surface area measurements, carried out by the various techniques described previously (laser diffraction analysis using the Laser Scattering Particle Size Distribution Analyzer Malvern model Mastersizer 3000 according to the protocol described in the description and by the BET method (Brunauer, Emmett and Teller Method) with the “Micromeritics FlowSorb II 2300” equipment according to the protocol described in the description) and used for characterizing ferrite powders obtained according to the present disclosure, show that the particles P₃ obtained in Example 2 thanks to this high-energy two-step grinding method have a specific surface area of 72 m²/g and a diameter well below 200 nm.

The particle size distribution of the ferrite particles P₃ thus obtained is as follows: d₉₀=117 nm; d₅₀=78 nm and d₁₀=50 nm. These results are consistent with the measurements obtained by SEM.

The particle size distribution of the ferrite particles P₂ thus obtained is as follows: d₉₀=1.149 μm; d₅₀=0.465 μm and d₁₀=0.196 μm. These results are consistent with the SEM measurements obtained.

Pressing and Sintering of the Ferrite Particles after Grinding

The ferrite particles P₃ obtained above are shaped by uniaxial pressing in toroid in APC7 format. The shaped material is then densified by sintering either at 850° C. or at 900° C.

The microstructure of the material sintered at 900° C. was observed by SEM-EBSD. The observation of grain sizes, i.e. the diameter of the equivalent circumscribed sphere of said particles dₛ=√S/π, where S is the surface of the equivalent sphere, was carried out by analysis of the crystalline orientation mapping. The equivalent diameters observed are less than 200 nm.

Table 3 shows the distribution of equivalent diameters of each grain size category observed by SEM-EBSD:

TABLE 3

| Surf. (μm²) | Approx. Fraction (%) | Grain size √ S / π (nm) |
|---|---|---|
| 0.005 | 23 | 40 |
| 0.015 | 20 | 69 |
| 0.025 | 17 | 89 |
| 0.035 | 11 | 106 |
| 0.045 | 9 | 120 |
| 0.055 | 6 | 132 |
| 0.065 | 3 | 144 |
| 0.075 | 3 | 155 |
| 0.085 | 1 | 164 |
| 0.095 | 2 | 174 |
| 0.105 | 2 | 183 |
| 0.115 | 1 | 191 |

The magnetic permeability of the materials thus obtained is characterized between 1 and 500 MHz using a Keysight model E₄₉₉₁B impedance meter according to the protocol described in the description. FIG. 1 presents the value of permeability and tan(δ_{μ}) according to the frequency for each of the two materials sintered at 850° C. and 900° C., as well as for a material that followed a conventional ceramic manufacturing method and was sintered at three different sintering temperatures (1180, 1140, and 1100° C.).

FIG. 1 presents the real value of the permeability μ′ and tan (δμ) (indicated “tan δ”) according to the frequency for the two materials obtained according to the disclosure (“high-energy method”) sintered at 850° C. and 900° C. Between these two temperatures, the performance of the materials changes. If a loss threshold tan (δμ) is set at 0.1, the method according to the disclosure enables the use of the material sintered at 850° C. up to about 250 MHz with a μᵣ between 13 and 16 (over the interval 1-250 MHz) against 160 MHz with a μᵣ between 21 and 25 (over the interval 1-160 MHz) for the material sintered at 900° C.

It is therefore observed that the performance of materials obtained according to the method of the disclosure (“high-energy method”) changes between the two sintering temperatures. For a loss threshold tan (δ_{μ}) set at 0.1 (low magnetic losses), the method according to the disclosure enables the use of:
the material sintered at 850° C. up to about 250 MHz with a μᵣ of between 13 and 16 (over the interval 1-250 MHz), and
the material sintered at 900° C. up to about 160 MHz with a μᵣ of between 21 and 25 (over the interval 1-160 MHz).

In contrast, for the material obtained in Example 1 by a comparative method (“low-energy method”), it is observed that the change in sintering temperature does not have a significant impact on the frequency loss threshold. It is indeed noted that, regardless of the sintering temperature (1180, 1140, or 1100° C.), if a loss threshold tan(δ_{μ}) is set at 0.1 (low magnetic losses), the maximum frequency of use of the material is not modified and remains at 15 MHz in all three cases. It should be noted that materials not obtained by the method according to the disclosure cannot be sintered at a lower temperature, since their densification is not sufficient. Such a material is therefore unusable in the VHF and UHF frequency range, unlike the material from the method according to the disclosure, which can be used up to frequencies of 160 MHz (sintered at 900° C.) or 250 MHz (sintered at 850° C.).

The method according to the disclosure therefore advantageously enables extending the frequency range of use of ferrite materials, and in particular materials of the NiₐZn_{b}Cu_{c}Co_{d}MnₑFe_{2-δ}O₄ type, as described above, and also enables adapting the characteristics of the material by modulating the sintering temperature.

### Example 3: Grinding Method According to the Disclosure

The following raw materials are selected and weighed according to Table 4:

TABLE 4

| Raw materials | Quantity (g) |
|---|---|
| Fe₂O₃ | 1910.8 |
| NiO | 677.7 |
| Co₃O₄ | 50.4 |
| ZnO | 361.2 |

### Preparation of the Ferrite Particles:

The protocol for preparing the ferrite particles is the same as that of Examples 1 and 2, except for the composition of raw materials, which is as described in Table 4.

The ferrite particles P_{1′} obtained have a specific surface area typically between 2 m²/g and 4 m²/g, a diameter deo of about 30 μm, and have the following composition:

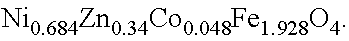

### Grinding of the Ferrite Particles:

The ferrite particles P₁ obtained above are ground in two steps, by an attrition mill under the reference DYNO MILL ECM AP 05 from the WAB Group.

First step S₁:
the ferrite particles P₁ are suspended in an aqueous slurry, typically at about 1.6 kg/L of ferrite powder/deionized water,
2% by weight in relation to the total weight of the slurry of dispersing agent (Dolapix CE64) is added to the slurry,
the slurry is ground for 5.5 hours with yttria-stabilized zirconium oxide balls of 0.3 mm in diameter, with the following parameters:
   mill speed: 12 m/s
   energy E₁: between 2.8 and 3.3 kWh/kg

At the end of step S₁, the ferrite particles P₂ are obtained.

Second step S₂:
1.7% of dispersing agent (Dolapix CE64) by weight relative to the total weight is added to the ground ferrite suspension in the previous step,
the slurry is ground for 8 hours with yttria-stabilized zirconium oxide balls of 0.1 mm diameter, with the following parameters:
   mill speed: 14 m/s
   energy E₂: between 6.3 and 7.9 kWh/kg

At the end of step S_{2′}, the ferrite particles P_{3′} are obtained.

The particles thus obtained are observed by Scanning Electron Microscopy (SEM). The particle size and specific surface area measurements were carried out by the various techniques described previously (laser diffraction analysis using the Laser Scattering Particle Size Distribution Analyzer Malvern model Mastersizer 3000 according to the protocol described in the description and by the BET method (Brunauer, Emmett and Teller Method) with the “Micromeritics FlowSorb II 2300” equipment according to the protocol described in the description).

The particle size measurements show that the particles P_{3′} obtained thanks to this high-energy two-step grinding method, according to the disclosure, have a specific surface area of 91 m²/g and a diameter less than 150 nm (SEM analysis).

The particle size distribution of the ferrite particles P_{3′} thus obtained is as follows: d₉₀₌₁₀₆ nm; d₅₀=68 nm and d₁₀=40 nm.

The particle size distribution of the ferrite particles P_{2′} thus obtained is as follows: d₉₀=0.769 μm; d₅₀=0.420 μm and d₁₀=0.157 μm.

Pressing and Sintering of the Ferrite Particles after Grinding

The ferrite particle powder P₃ obtained above is shaped by uniaxial pressing in toroid form in APC7 format. The shaped material is then densified by sintering at 820° C.

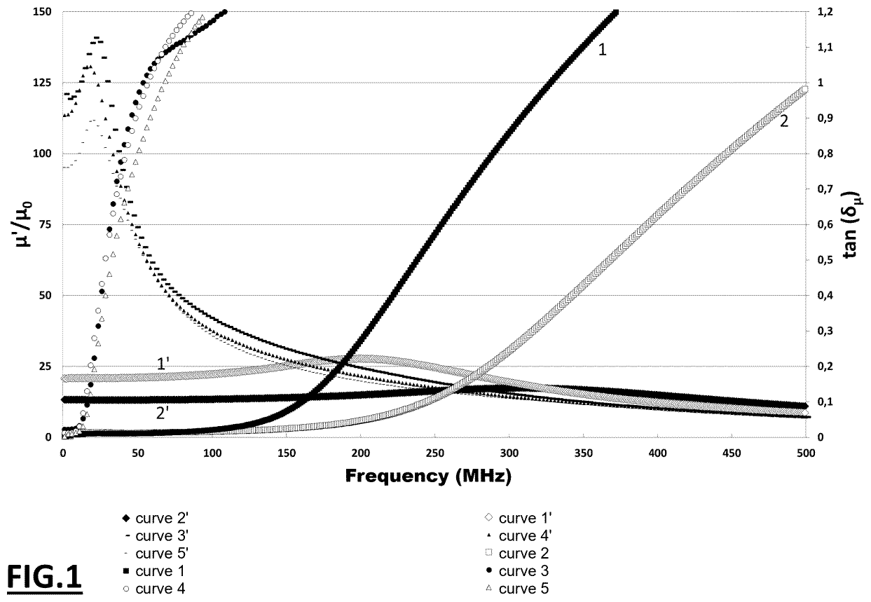

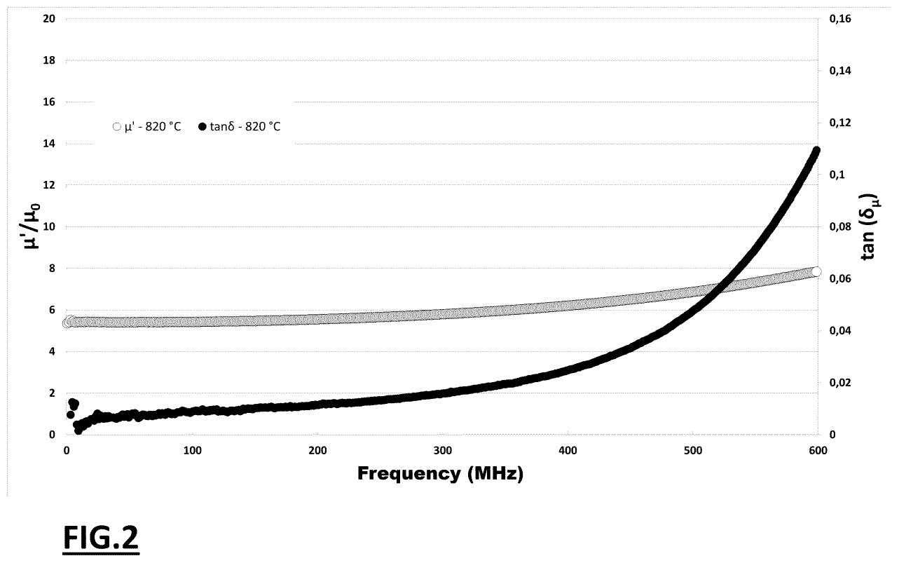

The magnetic permeability of the material thus obtained is characterized using a Keysight model E4991B impedance meter between 1 and 600 MHz according to the previously described protocol. FIG. 2 presents the value of the permeability and tan (Ou) according to the frequency of this material.

It is observed that for a loss threshold tan(δ_{μ}) set at 0.1, the method according to the disclosure enables the use of this material up to about 590 MHz with a μᵣ of between 5 and 8 (over the interval 1-590 MHz). Such a material is therefore usable in the VHF frequency range, and even beyond.

By varying the composition of a material manufactured according to the method of the disclosure, the frequency ranges in which it is usable can be increased. It is therefore possible, with the method of the disclosure, to manufacture materials that can operate in the VHF and UHF frequency ranges.

What is claimed is:

1. A method for preparing a ferrite material, the method comprising:
a step S₁ of grinding ferrite particles P₁ with grinding balls B₁ to obtain ferrite particles P₂,
wherein a diameter d₉₀ of the ferrite particles P₂ are smaller than a diameter d₉₀ of the ferrite particles P₁, and
wherein the step S₁ is carried out at an energy E₁ greater than 1.5 kWh/kg; and
a step S₂ of grinding the ferrite particles P₂ with grinding balls B₂ to obtain ferrite particles P₃,
wherein a diameter d₉₀ of the ferrite particles P₃ are smaller than the diameter d₉₀ of particles P₂, and
wherein the step S₂ is carried out at an energy E₂ greater than 5 kWh/kg,
wherein a diameter of the grinding balls B₁ are greater than a diameter of the grinding balls B₂.

2. The method according to claim 1, wherein the ferrite particles P₁ comprise particles of iron oxide (Fe₂O₃) and of one or more oxides chosen from nickel oxide (NiO), cobalt oxide (CoO), zinc oxide (ZnO), manganese oxide (MnO), or copper oxide (CuO).

3. The method according to claim 1, wherein the ferrite particles P₁ have a specific surface area of at least 2 m²/g.

4. The method according to claim 1, wherein the diameter d₉₀ of the ferrite particles P₁ is less than 50 μm.

5. The method according to claim 1, wherein the diameter d₉₀ of the ferrite particles P₂ is less than 1.5 μm.

6. The method according to claim 1, wherein the diameter d₉₀ of the ferrite particles P₃ is less than 200 nm.

7. The method according to claim 1, wherein the ferrite particles P₃ have a specific surface area of at least 20 m²/g.

8. The method according to claim 1, wherein the diameter of the grinding balls B₁ is between 0.3 mm and 1 mm.

9. The method according to claim 1, wherein the diameter of the grinding balls B₂ is less than 0.3 mm.

10. The method according to claim 1, wherein the grinding balls B₁ and the grinding balls B₂ comprise zirconium oxide balls.

11. The method according to claim 1, wherein, during step and/or steps S₁ and/or S₂ of grinding, the ferrite particles P₁ and/or P₂ are in a suspension.

12. The method according to claim 11, wherein the suspension comprises a dispersing agent.

13. The method according to claim 1, wherein the ferrite particles P₁ are obtained by a calcination step of oxide and/or carbonate powder, the calcination step being carried out at a temperature ranging from 800° C. to 1100° C. and for a duration ranging from 2 h to 4 h.

14. The method according to claim 1, wherein the step S₂ is followed by a pressing step of the ferrite particles P₃ to obtain the ferrite material.

15. The method according to claim 14, wherein the pressing step is preceded by a coating or atomization step of the ferrite particles P₃.

16. The method according to claim 14, wherein the pressing step of particles P₃ is followed by a sintering step.

17. The method according to claim 16, wherein the sintering step is carried out at a plateau temperature of less than 1000° C.

18. The method according to claim 17, wherein the ferrite material obtained has the following composition: 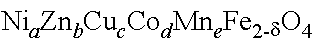
with:
$$2 ( a + b + c + d + e ) + 3 ( 2 - δ ) = 8 ,$$
$$0.05 \leq b \leq 0.5 ,$$
$$0 \leq c \leq 0.25 ,$$
$$0.005 \leq d \leq 0.25 ,$$
$$0 \leq e \leq 0.1 , and$$
$$0 \leq δ \leq 0.08 .$$

19. A ferrite material obtained by the method according to claim 17, comprising a microstructure having grain size less than 200 nm.

20. The method according to claim 1, wherein the energy E₁ is greater than 2 kWh/kg and wherein the energy E₂ is greater than 5.5 kWh/kg.
